(19) United States
(12) Patent Application Publication
(10) Pub. No.: US 2026/0093821 A1
(43) Pub. Date: Apr. 2, 2026

(54) Using Machine-Learning Models to Identify Suspicious Content

(71) Applicant: Sophos Limited, Abingdon (GB)

(72) Inventors: Andrew James THOMAS, Abingdon (GB); Santosh Kumar BARNWAL, Burnaby (CA); Armen Joseph CHAKMAKJIAN, Arlington, MA (US); Jaydatt Jitendriya DESAI, Ahmedabad (IN); Tom FOUCHA, Southhaven, MS (US); Younghoo LEE, Asquith (AU); John MEARS, Abingdon (GB); Balakrishnan RAJKUMAR, Tamil Nadu (IN); Rahul SINHA, Ahmedabad (IN); Vivek Rudraduttbhai YAGNIK, Coquitlam (CA)

(73) Assignee: Sophos Limited, Abingdon (GB)

(21) Appl. No.: 19/063,991

(22) Filed: Feb. 26, 2025

(30) Foreign Application Priority Data
Sep. 30, 2024 (IN) 202411073637

(51) Int. Cl. G06F 21/57; H04L 51/212

(52) U.S. Cl. CPC G06F 21/577; H04L 51/212

(57) ABSTRACT

A security application provides a prompt and content that includes text and one or more images as input to a multimodal large language model (LLM). The security application receives, from the multimodal LLM and responsive to providing the prompt and the content, a summary report of the content, the summary report including a text summary of the content. The security application extracts features from the summary report. The security application provides the extracted features as input to one or more pre-trained lightweight machine-learning models. The security application receives, from the one or more lightweight machine-learning models, a classification of the content, wherein the classification indicates whether the content is suspicious.

### FIELD

This application is a non-provisional application that claims priority under 35 U.S.C. § 119(d) to Indian Provisional Patent Application No. 202411073637, filed on Sep. 30, 2024 and entitled “Using Machine-Learning Models to Identify Suspicious Content,” the content of which is incorporated by reference herein in its entirety.

### FIELD

Embodiments relate generally to determining whether content that includes text and one or more images is suspicious. More particularly, embodiments relate to methods, systems, and computer-readable media that use a multimodal large language model and a lightweight machine-learning model.

### BACKGROUND

Traditional spam filters may fail to identify sophisticated phishing attempts due to the spam filters'reliance on simple text analysis. Simple machine-learning models used for spam are limited in effectiveness because of the limits the training data used to train these machine-learning models. For example, if the training data lacks examples of content that utilizes certain phishing tactics, the machine-learning models may fail to identify threats posed by content that utilizes such tactics.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method to identify suspicious content includes providing a prompt and content that includes text and one or more images as input to a multimodal large language model (LLM). The method further includes receiving, from the multimodal LLM and responsive to providing the prompt and the content, a summary report of the content, the summary report including a text summary of the content. The method further includes extracting features from the summary report. The method further includes providing the extracted features as input to one or more pre-trained lightweight machine-learning models. The method further includes receiving, from the one or more lightweight machine-learning models, a classification of the content, wherein the classification indicates whether the content is suspicious.

In some embodiments, the method further includes before providing the content to the multimodal LLM, determining that the content is associated with a risk factor; where the risk factor is selected from a group of the content being from an external email message, a suspicious reputation associated with a sender of the content, the content is from an email message associated with a new sender or a new domain, an identification of a suspicious Uniform Resource Locator (URL) that is part of the content, prohibited words that are associated with the content, and combinations thereof and where providing the content to the multimodal LLM is performed responsive to determining that the content is associated with the risk factor. In some embodiments, the summary report includes one or more parameters selected from a group of an overview of content of an email message, an identification of suspicious elements associated with an email domain, an identification of suspicious text, an identification of a suspicious link, an identification of a suspicious image, an identification of an impersonation, and combinations thereof. In some embodiments, the summary report includes a first suspiciousness score for the content and the classification includes a second suspiciousness score for the content. In some embodiments, the content is from a website and the classification includes a probability that the website is a type of website selected from a group of gambling, weapons, sports, games, and combinations thereof.

In some embodiments, the method further includes responsive to the classification indicating that the content is suspicious, performing a remedial action. In some embodiments, the content is an original email message and the remedial action is selected from a group of deleting the email message, quarantining the email message, delivering the email message with a warning, delivering the email message with the summary report, delivering a modified email message where an original Uniform Resource Locator (URL) from the original email message is replaced with a modified URL, and combinations thereof. In some embodiments, the content is from a website and the remedial action includes blocking users from accessing the website.

In some embodiments, extracting the features from the summary report comprises determining a respective Term Frequency-Inverse Document Frequency (TF-IDF) score for a plurality of terms in the text summary of the content. In some embodiments, extracting the features from the summary report comprises obtaining one or more embeddings representative of the content from the multimodal LLM. In some embodiments, obtaining the one or more embeddings representative of the content includes obtaining, from the multimodal LLM, a respective description of the one or more images and generating, by the multimodal LLM, the one or more embeddings based on the text and the descriptions of the one or more images. In some embodiments, the multimodal LLM includes a first component that generates descriptions of the one or more images and a second component that generates the one or more embeddings.

A system comprises one or more processors and one or more computer-readable media, having instructions stored thereon that, when executed by the one or more processors, cause the one or more processors to perform operations. The operations include providing a prompt and content that includes text and one or more images as input to a multimodal LLM; receiving, from the multimodal LLM and responsive to providing the prompt and the content, a summary report of the content, the summary report including a text summary of the content; extracting features from the summary report; providing the extracted features as input to one or more pre-trained lightweight machine-learning models; and receiving, from the one or more lightweight machine-learning models, a classification of the content, wherein the classification indicates whether the content is suspicious.

In some embodiments, the operations further includes before providing the content to the multimodal LLM, determining that the content is associated with a risk factor, where the risk factor is selected from a group of the content being from an external email message, a suspicious reputation associated with a sender of the content, the content is from an email message associated with a new sender or a new domain, an identification of a suspicious Uniform Resource Locator (URL) that is part of the content, prohibited words that are associated with the content, and combinations thereof and where providing the content to the multimodal LLM is performed responsive to determining that the content is associated with the risk factor. In some embodiments, the summary report includes one or more parameters selected from a group of an overview of content of an email message, an identification of suspicious elements associated with an email domain, an identification of suspicious text, an identification of a suspicious link, an identification of a suspicious image, an identification of an impersonation, and combinations thereof. In some embodiments, the summary report includes a first suspiciousness score for the content and the classification includes a second suspiciousness score for the content.

A non-transitory computer-readable medium with instructions stored thereon that, responsive to execution by a processing device, causes the processing device to perform operations. The operations include providing a prompt and content that includes text and one or more images as input to a multimodal LLM; receiving, from the multimodal LLM and responsive to providing the prompt and the content, a summary report of the content, the summary report including a text summary of the content; extracting features from the summary report; providing the extracted features as input to one or more pre-trained lightweight machine-learning models; and receiving, from the one or more lightweight machine-learning models, a classification of the content, wherein the classification indicates whether the content is suspicious.

In some embodiments, the operations further includes before providing the content to the multimodal LLM, determining that the content is associated with a risk factor, where the risk factor is selected from a group of the content being from an external email message, a suspicious reputation associated with a sender of the content, the content is from an email message associated with a new sender or a new domain, an identification of a suspicious Uniform Resource Locator (URL) that is part of the content, prohibited words that are associated with the content, and combinations thereof and where providing the content to the multimodal LLM is performed responsive to determining that the content is associated with the risk factor. In some embodiments, the summary report includes one or more parameters selected from a group of an overview of content of an email message, an identification of suspicious elements associated with an email domain, an identification of suspicious text, an identification of a suspicious link, an identification of a suspicious image, an identification of an impersonation, and combinations thereof. In some embodiments, the summary report includes a first suspiciousness score for the content and the classification includes a second suspiciousness score for the content.

### BRIEF DESCRIPTION OF THE DRAWINGS

FIG. 1 depicts a block diagram of an example threat management system, according to some embodiments described herein.

FIG. 2 is a block diagram of an example computing device, according to some embodiments described herein.

FIG. 3 is a block diagram of an example security system that includes a security server and one or more machine-learning servers, according to some embodiments described herein.

FIG. 4 is an example prompt to an LLM to analyze an email message, according to some embodiments described herein.

FIG. 5A is an example image of an email message, according to some embodiments described herein.

FIG. 5B is an example summary report for the email message of FIG. 5A, generated by an LLM, according to some embodiments described herein.

FIG. 6A is another example image of an email message, according to some embodiments described herein.

FIG. 6B is another example summary report for the email message, according to some embodiments described herein.

FIG. 7 is another example image of an email message and a corresponding example summary report, according to some embodiments described herein.

FIG. 8A is an example image of a gambling website, according to some embodiments described herein.

FIG. 8B is an example summary report for the gambling website of FIG. 8A, according to some embodiments described herein.

FIG. 9 is an example image of a non-English gambling website, according to some embodiments described herein.

FIG. 10 includes two example websites, according to some embodiments described herein.

FIG. 11 is an example user interface that includes a warning to a recipient about the email message based on the summary report, according to some embodiments described herein.

FIG. 12 is a flow diagram of an example method to classify a suspiciousness of content, according to some embodiments described herein.

### DETAILED DESCRIPTION

### Overview

Phishing emails often include content that calls the reader to take urgent actions, such as verifying delivery details for a package, address payment discrepancies, etc. where if the user performs the actions, it results in leakage of user's private information (e.g., address, bank or other financial information, etc.) to a malicious actor that sent the phishing email. The urgent actions may direct the recipient to malicious Uniform Resource Locators (URLs) aimed at capturing user credentials and/or information. Many phishing emails closely mimic legitimate communications, making detection of such emails difficult for conventional spam filters. Previous techniques for determining suspicious content have included using machine-learning model to perform data collection, feature extraction, and model training and deployment. However, the machine-learning models rely on familiar words from training datasets and may not recognize new phishing formats.

Classification of websites as being Not Safe For Work (NSFW) involves categorizing websites into groups like gambling, weapons, sports, and games, where websites that include weapons and gambling are NSFW and are therefore blocked from access within a business environment. Previous techniques for identifying NSFW websites include data collection, Hypertext Markup Language (HTML) content extraction, and feature creation. However, these previous techniques are limited by their inability to interpret non-text objects within images.

The security application discussed below advantageously determines the suspiciousness of content (including email as well as website content) by using two different machine-learning models. The determination of suspiciousness is with a low rate of false positives (erroneous identification of legitimate content as suspicious) and false negatives (not recognizing certain suspicious content). The security application determines whether content is suspicious based on text and images associated with the content. The security application sends the content along with an appropriate prompt to a multimodal Large Language Model (LLM) and obtains a summary report regarding the content. The security application extracts features from the summary report and provides the extracted features to a lightweight machine-learning model. For example, if the content is from an email message the extracted features may be determined based on Term Frequency-Inverse Document Frequency (TF-IDF) scores. If the content is from a website, the extracted features may be embeddings. The lightweight machine-learning model returns a classification of the content that indicates whether the content is suspicious. The classification may include a binary determination of suspiciousness, a suspiciousness score, and/or in cases where the content is a website, a classification of the website as being NSFW (with potential classification of the website as particular category within NSFW, such as gambling).

### Threat Management System

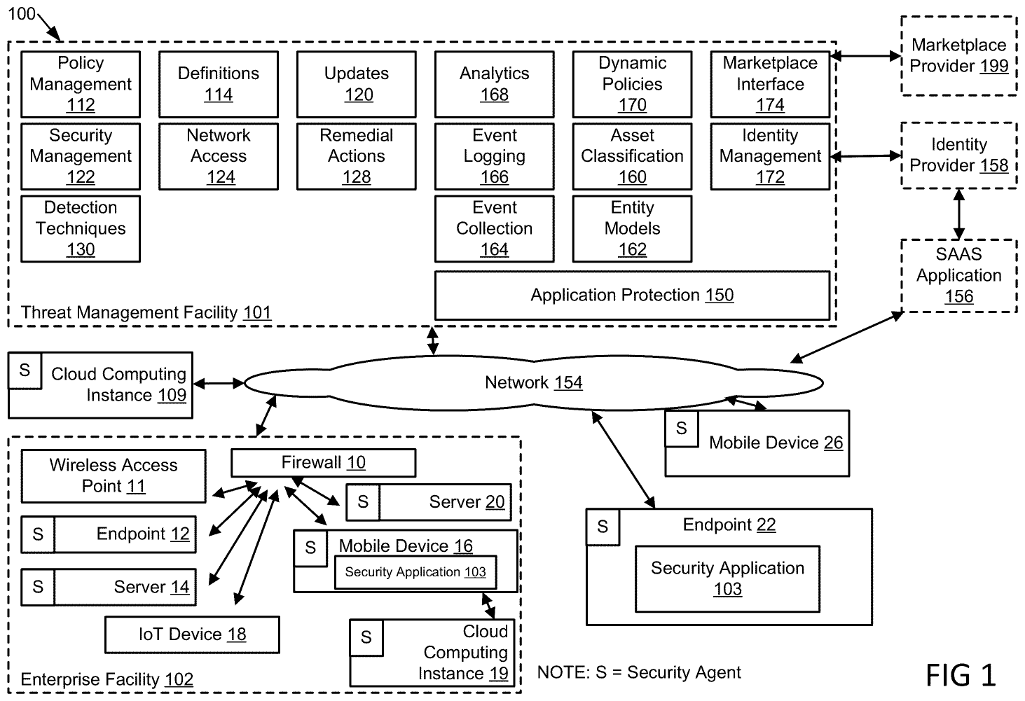

FIG. 1 depicts a block diagram of a threat management system 100 providing protection against a plurality of threats, such as malware, viruses, spyware, cryptoware, adware, ransomware, trojans, spam, intrusion, policy abuse, improper configuration, vulnerabilities, improper access, uncontrolled access, and more. A threat management facility or network monitor 100 may communicate with, coordinate, and control operation of security functionality at different control points, layers, and levels within the system 100. A number of capabilities may be provided by the threat management facility 101, with an overall goal to intelligently monitor network traffic from endpoints/hosts to known security product update sites. The threat management facility 101 can monitor the traffic passively and analyze the traffic. The threat management facility 101 may be or may include a gateway such as a web security appliance that is actively routing and/or assessing the network requests for security purposes. Another overall goal is to provide protection needed by an organization that is dynamic and able to adapt to changes in compute instances and new threats due to personal or unmanaged devices using the enterprise network. According to various aspects, the threat management facility 101 may provide protection from a variety of threats to a variety of compute instances in a variety of locations and network configurations.

As one example, users of the threat management facility 101 may define and enforce policies that control access to and use of compute instances, networks, and data. Administrators may update policies such as by designating authorized users and conditions for use and access. The threat management facility 101 may update and enforce those policies at various levels of control that are available, such as by directing compute instances to control the network traffic that is allowed to traverse firewalls and wireless access points, applications, and data available from servers, applications, and data permitted to be accessed by endpoints, and network resources and data permitted to be run and used by endpoints. The threat management facility 101 may provide many different services, and policy management may be offered as one of the services.

Turning to a description of certain capabilities and components of the threat management system 100, an example enterprise facility 102 may be or may include any networked computer-based infrastructure. For example, the enterprise facility 102 may be corporate, commercial, organizational, educational, governmental, or the like. As home networks can also include more compute instances at home and in the cloud, an enterprise facility 102 may also or instead include a personal network such as a home or a group of homes. The enterprise facility's 102 computer network may be distributed amongst a plurality of physical premises, such as buildings on a campus, and located in one or in a plurality of geographical locations. The configuration of the enterprise facility as shown as one example, and it will be understood that there may be any number of compute instances, less or more of each type of compute instances, and other types of compute instances.

As shown, the example enterprise facility includes a firewall 10, a wireless access point 11, an endpoint 12, a server 14, a mobile device 16, an appliance or Internet-of-Things (IoT) device 18, a cloud computing instance 19, and a server 20. One or more of 10-20 may be implemented in hardware (e.g., a hardware firewall, a hardware wireless access point, a hardware mobile device, a hardware IoT device, a hardware etc.) or in software (e.g., a virtual machine configured as a server or firewall or mobile device). While FIG. 1 shows various elements 10-20, these are for example only, and there may be any number or types of elements in a given enterprise facility. For example, in addition to the elements depicted in the enterprise facility 102, there may be one or more gateways, bridges, wired networks, wireless networks, virtual private networks, virtual machines or compute instances, computers, and so on.

The threat management facility 101 may include certain facilities, such as a policy management facility 112, security management facility 122, update facility 120, definitions facility 114, network access rules facility 124, remedial action facility 128, detection techniques facility 130, application protection facility 150, asset classification facility 160, entity model facility 162, event collection facility 164, event logging facility 166, analytics facility 168, dynamic policies facility 170, identity management facility 172, and marketplace management facility 174, as well as other facilities. For example, there may be a testing facility, a threat research facility, and other facilities. It should be understood that the threat management facility 101 may be implemented in whole or in part on a number of different compute instances, with some parts of the threat management facility on different compute instances in different locations. For example, some or all of one or more of the various facilities 100, 112-174 may be provided as part of a security agent S that is included in software running on a compute instance 10-26 within the enterprise facility. Some or all of one or more of the facilities 100, 112-174 may be provided on the same physical hardware or logical resource as a gateway, such as a firewall 10, or wireless access point 11. Some or all of one or more of the facilities may be provided on one or more cloud servers that are operated by the enterprise or by a security service provider, such as the cloud computing instance 109.

In various implementations, a marketplace provider 199 may make available one or more additional facilities to the enterprise facility 102 via the threat management facility 101. The marketplace provider may communicate with the threat management facility 101 via the marketplace interface facility 174 to provide additional functionality or capabilities to the threat management facility 101 and compute instances 10-26. As examples, the marketplace provider 199 may be a third-party information provider, such as a physical security event provider; the marketplace provider 199 may be a system provider, such as a human resources system provider or a fraud detection system provider; the marketplace provider may be a specialized analytics provider; and so on. The marketplace provider 199, with appropriate permissions and authorization, may receive and send events, observations, inferences, controls, convictions, policy violations, or other information to the threat management facility. For example, the marketplace provider 199 may subscribe to and receive certain events, and in response, based on the received events and other events available to the marketplace provider 199, send inferences to the marketplace interface, and in turn to the analytics facility 168, which in turn may be used by the security management facility 122. According to some implementations, the marketplace provider 199 is a trusted security vendor that can provide one or more security software products to any of the compute instances described herein. In this manner, the marketplace provider 199 may include a plurality of trusted security vendors that are used by one or more of the illustrated compute instances.

The identity provider 158 may be any remote identity management system or the like configured to communicate with an identity management facility 172, e.g., to confirm identity of a user as well as provide or receive other information about users that may be useful to protect against threats. In general, the identity provider may be any system or entity that creates, maintains, and manages identity information for principals while providing authentication services to relying party applications, e.g., within a federation or distributed network. The identity provider may, for example, offer user authentication as a service, where other applications, such as web applications, outsource the user authentication step to a trusted identity provider.

The identity provider 158 may provide user identity information, such as multi-factor authentication, to a software-as-a-service (SaaS) application. Centralized identity providers may be used by an enterprise facility instead of maintaining separate identity information for each application or group of applications, and as a centralized point for integrating multifactor authentication. The identity management facility 172 may communicate hygiene, or security risk information, to the identity provider 158. The identity management facility 172 may determine a risk score for a particular user based on events, observations, and inferences about that user and the compute instances associated with the user. If a user is perceived as risky, the identity management facility 172 can inform the identity provider 158, and the identity provider 158 may take steps to address the potential risk, such as to confirm the identity of the user, confirm that the user has approved the SaaS application access, remediate the user's system, or such other steps as may be useful.

The threat protection provided by the threat management facility 101 may extend beyond the network boundaries of the enterprise facility 102 to include clients (or client facilities) such as an endpoint 22 outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop. While threats may come from a variety of sources, such as from network threats, physical proximity threats, secondary location threats, the compute instances 10-26 may be protected from threats even when a compute instance 10-26 is not connected to the enterprise facility 102 network, such as when compute instances 22, 26 use a network that is outside of the enterprise facility 102 and separated from the enterprise facility 102, e.g., by a gateway, a public network, and so forth. In some implementations, the endpoint 22 and/or the mobile device 26 include a security application 103 that is discussed in greater detail below.

In some implementations, compute instances 10-26 may communicate with cloud applications, such as SaaS application 156. The SaaS application 156 may be an application that is used by but not operated by the enterprise facility 102. Example commercially available SaaS applications 156 include Salesforce, Amazon Web Services (AWS) applications, Google Apps applications, Microsoft Office 365 applications, and so on. A given SaaS application 156 may communicate with an identity provider 158 to verify user identity consistent with the requirements of the enterprise facility 102. The compute instances 10-26 may communicate with an unprotected server (not shown) such as a web site or a third-party application through an internetwork 154 such as the Internet or any other public network, private network or combination of these.

Aspects of the threat management facility 101 may be provided as a stand-alone solution. In other implementations, aspects of the threat management facility 101 may be integrated into a third-party product. An application programming interface (e.g., a source code interface) may be provided such that aspects of the threat management facility 101 may be integrated into or used by or with other applications. For instance, the threat management facility 101 may be stand-alone in that it provides direct threat protection to an enterprise or computer resource, where protection is subscribed to directly. Alternatively, the threat management facility may offer protection indirectly, through a third-party product, where an enterprise may subscribe to services through the third-party product, and threat protection to the enterprise may be provided by the threat management facility 101 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In some implementations, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in the security agent of an endpoint 12, in a wireless access point 11 or firewall 10, as part of application protection 150 provided by the cloud, and so on.

In an implementation, the security management facility 122 may provide for email security and control, for example to target spam, viruses, spyware and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of application protection 150 provided by the cloud, and so on.

In an implementation, security management facility 122 may provide for web security and control, for example, to detect or block viruses, spyware, malware, unwanted applications, help control web browsing, and the like, which may provide comprehensive web access control enabling safe, productive web browsing. Web security and control may provide Internet use policies, reporting on suspect compute instances, security and content filtering, active monitoring of network traffic, uniform resource identifier (URI) filtering, and the like. Aspects of the web security and control may be provided, for example, in the security agent of an endpoint 12, in a wireless access point 11 or firewall 10, as part of application protection 150 provided by the cloud, and so on.

According to one implementation, the security management facility 122 may provide for network monitoring and access control, which generally controls access to and use of network connections, while also allowing for monitoring as described herein. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. According to various implementations, a VPN may be treated in the same manner as a physical network. Aspects of network access control may be provided, for example, in the security agent of an endpoint 12, in a wireless access point 11 or firewall 10, as part of application protection 150 provided by the cloud, e.g., from the threat management facility 101 or other network resource(s).

The security management facility 122 may also provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of application protection 150 provided by the cloud, and so on.

The security management facility 122 may provide also for reputation filtering, which may target or identify sources of known malware. For instance, reputation filtering may include lists of URIs of known sources of malware or known suspicious internet protocol (IP) addresses, code authors, code signers, or domains, that when detected may invoke an action by the threat management facility 101. Based on reputation, potential threat sources may be blocked, quarantined, restricted, monitored, or some combination of these, before an exchange of data can be made. Aspects of reputation filtering may be provided, for example, in the security agent of an endpoint 12, in a wireless access point 11 or firewall 10, as part of application protection 150 provided by the cloud, and so on. In some implementations, some reputation information may be stored on a compute instance 10-26, and other reputation data available through cloud lookups to an application protection lookup database, such as may be provided by application protection 150.

In some implementations, information may be sent from the enterprise facility 102 to a third party, such as a security vendor, or the like, which may lead to improved performance of the threat management facility 101. In general, feedback may be useful for any aspect of threat detection. For example, the types, times, and number of virus interactions that an enterprise facility 102 experiences may provide useful information for the preventions of future virus threats. Feedback may also be associated with behaviors of individuals within the enterprise, such as being associated with most common violations of policy, network access, unauthorized application loading, unauthorized external device use, and the like. Feedback may enable the evaluation or profiling of client actions that are violations of policy that may provide a predictive model for the improvement of enterprise policies as well as detection of emerging security threats.

An update management facility 120 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In some implementations, updates may be provided to the enterprise facility's 102 network, where one or more compute instances on the enterprise facility's 102 network may distribute updates to other compute instances.

According to some implementations, network traffic associated with the update facility functions may be monitored to determine that personal devices and/or unmanaged devices are appropriately applying security updates. In this manner, even unmanaged devices may be monitored to determine that appropriate security patches, software patches, virus definitions, and other similar code portions are appropriately updated on the unmanaged devices.

The threat management facility 101 may include a policy management facility 112 that manages rules or policies for the enterprise facility 102. Example rules include access permissions associated with networks, applications, compute instances, users, content, data, and the like. The policy management facility 112 may use a database, a text file, other data store, or a combination to store policies. A policy database may include a block list, a black list, an allowed list, a white list, and more. As non-limiting examples, policies may include a list of enterprise facility 102 external network locations/applications that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. Example policies may be defined for an enterprise facility, application type, subset of application capabilities, organization hierarchy, compute instance type, user type, network location, time of day, connection type, or any other suitable definition. Policies may be maintained through the threat management facility 101, in association with a third party, or the like. For example, a policy may restrict instant messaging (IM) activity by limiting such activity to support personnel when communicating with customers. More generally, this may allow communication for departments as necessary or helpful for department functions, but may otherwise preserve network bandwidth for other activities by restricting the use of IM to personnel that need access for a specific purpose. In one implementation, the policy management facility 112 may be a stand-alone application, may be part of the network server facility 142, may be part of the enterprise facility 102 network, may be part of the client facility, or any suitable combination of these.

The policy management facility 112 may include dynamic policies that use contextual or other information to make security decisions. As described herein, the dynamic policies facility 170 may generate policies dynamically based on observations and inferences made by the analytics facility. The dynamic policies generated by the dynamic policy facility 170 may be provided by the policy management facility 112 to the security management facility 122 for enforcement.

The threat management facility 101 may provide configuration management as an aspect of the policy management facility 112, the security management facility 122, or a combination thereof. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 12, 14, 18, a version of a client firewall may be required to be running and installed. If the required version is installed but in a disabled state, the policy violation may prevent access to data or network resources. A remediation may be to enable the firewall. In another example, a configuration policy may disallow the use of uniform serial bus (USB) disks, and policy management 112 may require a configuration that turns off USB drive access via a registry key of a compute instance. Aspects of configuration management may be provided, for example, in the security agent of an endpoint 12, in a wireless access point 11 or firewall 10, as part of application protection 150 provided by the cloud, or any combination of these.

The policy management facility 112 may also require update management (e.g., as provided by the update facility 120). Update management for the security facility 122 and policy management facility 112 may be provided directly by the threat management facility 101, or, for example, by a hosted system. In some implementations, the threat management facility 101 may also provide for patch management, where a patch may be an update to an operating system, an application, a system tool, or the like, where one of the reasons for the patch is to reduce vulnerability to threats.

In some implementations, the security facility 122 and policy management facility 112 may push information to the enterprise facility 102 network and/or the compute instances 10-26, the enterprise facility 102 network and/or compute instances 10-26 may pull information from the security facility 122 and policy management facility 112, or there may be a combination of pushing and pulling of information. For example, the enterprise facility 102 network and/or compute instances 10-26 may pull update information from the security facility 122 and policy management facility 112 via the update facility 120, an update request may be based on a time period, by a certain time, by a date, on demand, or the like. In another example, the security facility 122 and policy management facility 112 may push the information to the enterprise facility's 102 network and/or compute instances 10-26 by providing notification that there are updates available for download and/or transmitting the information. In one implementation, the policy management facility 112 and the security facility 122 may work in concert with the update management facility 120 to provide information to the enterprise facility's 102 network and/or compute instances 10-26. In various implementations, policy updates, security updates, and other updates may be provided by the same or different modules, which may be the same or separate from a security agent running on one of the compute instances 10-26. Furthermore, the policy updates, security updates, and other updates may be monitored through network traffic to determine if endpoints or compute instances 10-26 correctly receive the associated updates.

As threats are identified and characterized, the definition facility 114 of the threat management facility 101 may manage definitions used to detect and remediate threats. For example, identity definitions may be used for recognizing features of known or potentially malicious code and/or known or potentially malicious network activity. Definitions also may include, for example, code or data to be used in a classifier, such as a neural network or other classifier that may be trained using machine learning. Updated code or data may be used by the classifier to classify threats. In some implementations, the threat management facility 101 and the compute instances 10-26 may be provided with new definitions periodically to include most recent threats. Updating of definitions may be managed by the update facility 120 and may be performed upon request from one of the compute instances 10-26, upon a push, or some combination. Updates may be performed at a specific a time period, on demand from a device 10-26, upon determination of an important new definition or a number of definitions, and so on.

A threat research facility (not shown) may provide a continuously ongoing effort to maintain the threat protection capabilities of the threat management facility 101 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 101 may control access to the enterprise facility 102 networks. A network access facility 124 may restrict access to certain applications, networks, files, printers, servers, databases, and so on. In addition, the network access facility 124 may restrict user access under certain conditions, such as the user's location, usage history, need-to-know data, job position, connection type, time of day, method of authentication, client-system configuration, or the like. Network access policies may be provided by the policy management facility 112, and may be developed by the enterprise facility 102, or pre-packaged by a supplier. Network access facility 124 may determine if a given compute instance 10-22 should be granted access to a requested network location, e.g., inside or outside of the enterprise facility 102. Network access facility 124 may determine if a compute instance 22, 26 such as a device outside the enterprise facility 102 may access the enterprise facility 102. For example, in some cases, the policies may require that when certain policy violations are detected, certain network access is denied. The network access facility 124 may communicate remedial actions that are necessary or helpful to bring a device back into compliance with policy as described below with respect to the remedial action facility 128. Aspects of the network access facility 124 may be provided, for example, in the security agent of the endpoint 12, in a wireless access point 11, in a firewall 10, as part of application protection 150 provided by the cloud, and so on.

In some implementations, the network access facility 124 may have access to policies that include one or more of a block list, a black list, an allowed list, a white list, an unacceptable network site database, an acceptable network site database, a network site reputation database, or the like of network access locations that may or may not be accessed by the client facility. Additionally, the network access facility 124 may use rule evaluation to parse network access requests and apply policies. The network access rule facility 124 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 101 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, MacOS, Linux, Android, iOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility may include entity models 162. The entity models may be used, for example, to determine the events that are generated by assets. For example, some operating systems may provide useful information for detecting or identifying events. For examples, operating systems may provide process and usage information that are accessed through an application programming interface (API). As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection facility 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, and cloud computing instances 19, 109. Events may range in granularity. An example event may be communication of a specific packet over the network. Another example event may be identification of an application that is communicating over a network. These and other events may be used to determine that a particular endpoint includes or does not include actively updated security software from a trusted vendor.

The event logging facility 166 may be used to store events collected by the event collection facility 164. The event logging facility 166 may store collected events so that they can be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility 122. Observations or inferences about events may also be logged by the event logging facility 166.

When a threat or other policy violation is detected by the security management facility 122, the remedial action facility 128 may be used to remediate the threat. Remedial action may take a variety of forms, including collecting additional data about the threat, terminating or modifying an ongoing process or interaction, sending a warning to a user or administrator from an IT department, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 122 may take any steps or deploy any measures suitable for addressing a detection of a threat, potential threat, policy violation or other event, code or activity that might compromise security of a computing instance 10-26 or the enterprise facility 102.

### Computing Device

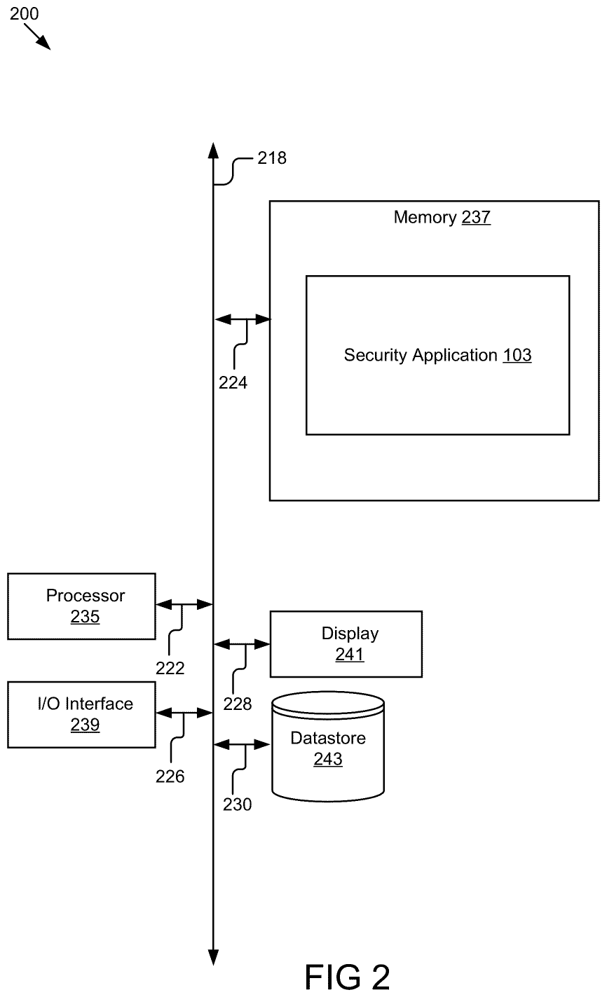

FIG. 2 is a block diagram of an example computing device 200 that may be used to implement one or more features described herein. Computing device 200 can be any suitable computer system, server, or other electronic or hardware device. In some embodiments, computing device 200 is part of the enterprise facility 102 in FIG. 1. For example, the computing device may be the mobile device 16, the server 13, the server 20, etc. In some embodiments, the computing device 200 is the endpoint 22 illustrated in FIG. 1.

In some embodiments, computing device 200 includes a processor 235, a memory 237, an input/output (I/O) interface 239, a display 241, and a datastore 243, all coupled via a bus 218. The processor 235 may be coupled to the bus 218 via signal line 222, the memory 237 may be coupled to the bus 218 via signal line 224, the I/O interface 239 may be coupled to the bus 218 via signal line 226, the display 241 may be coupled to the bus 218 via signal line 228, and the datastore 243 may be coupled to the bus 218 via signal line 230.

The processor 235 includes an arithmetic logic unit, a microprocessor, a general-purpose controller, or some other processor array to perform computations and provide instructions to a display device. Processor 235 processes data and may include various computing architectures including a complex instruction set computer (CISC) architecture, a reduced instruction set computer (RISC) architecture, or an architecture implementing a combination of instruction sets. Although FIG. 2 illustrates a single processor 235, multiple processors 235 may be included. In different embodiments, processor 235 may be a single-core processor or a multicore processor. Other processors (e.g., graphics processing units), operating systems, sensors, displays, and/or physical configurations may be part of the computing device 200.

The memory 237 may be a computer-readable media that stores instructions that may be executed by the processor 235 and/or data. The instructions may include code and/or routines for performing the techniques described herein. The memory 237 may be a dynamic random access memory (DRAM) device, a static RAM, or some other memory device. In some embodiments, the memory 237 also includes a non-volatile memory, such as a static random access memory (SRAM) device or flash memory, or similar permanent storage device and media including a hard disk drive, a compact disc read only memory (CD-ROM) device, a DVD-ROM device, a DVD-RAM device, a DVD-RW device, a flash memory device, or some other mass storage device for storing information on a more permanent basis. The memory 237 includes code and routines operable to execute the security application 103, which is described in greater detail below.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or datastore 243), and input/output devices can communicate via I/O interface 239. In another example, the I/O interface 239 can receive data, such as email messages, from a user device 115 and deliver the data to the security application 103. In some embodiments, the I/O interface 239 can connect to interface devices such as input devices (keyboard, pointing device, touchscreen, microphone, camera, scanner, sensors, etc.) and/or output devices (display devices, speaker devices, printers, monitors, etc.).

Some examples of interfaced devices that can connect to I/O interface 239 can include a display 241 that can be used to display content, e.g., an email message received from the sender. The display 241 can include any suitable display device such as a liquid crystal display (LCD), light emitting diode (LED), or plasma display screen, cathode ray tube (CRT), television, monitor, touchscreen, three-dimensional display screen, or other visual display device.

The datastore 243 may store data related to the security application 103. For example, the datastore 243 may store, with user permission, email messages, message identifiers, metadata corresponding to the email messages, etc. The datastore 243 may be coupled to the bus 218 via signal line 230.

In some embodiments, one or more components of the computing device 200 may not be present depending on the type of computing device 200. For example, if the computing device 200 is a server, the computing device 200 may not include the display 241.

FIG. 2 illustrates a computing device 200 that executes an example security application 103 stored in memory 237 of the computing device 200. The security application 103 provides a prompt and content that includes text and one or more images as input to a multimodal large language model (LLM). The text may include message heaters, HTML elements in a body of an email message that controls its styling, email body text, etc. The content may be an email message, a text message, a website, etc. The security application 103 receives, from the multimodal LLM and responsive to providing the prompt and the content, a summary report of the content, the summary report including a text summary of the content and a first suspiciousness score. The text summary may include a description of the text in the content and a description of the one or more images in the content.

The security application 103 extracts features from the summary report and provides the extracted features as input to one or more pre-trained lightweight machine-learning models. The security application 103 receives, from the one or more lightweight machine-learning models, a classification of the content that indicates whether the content is suspicious. The classification of the content may include a second suspicious score. If the content is a website, the classification of the content may include a probability that the content is a type of website, such as gambling, weapons, sports, and/or games.

### Security System

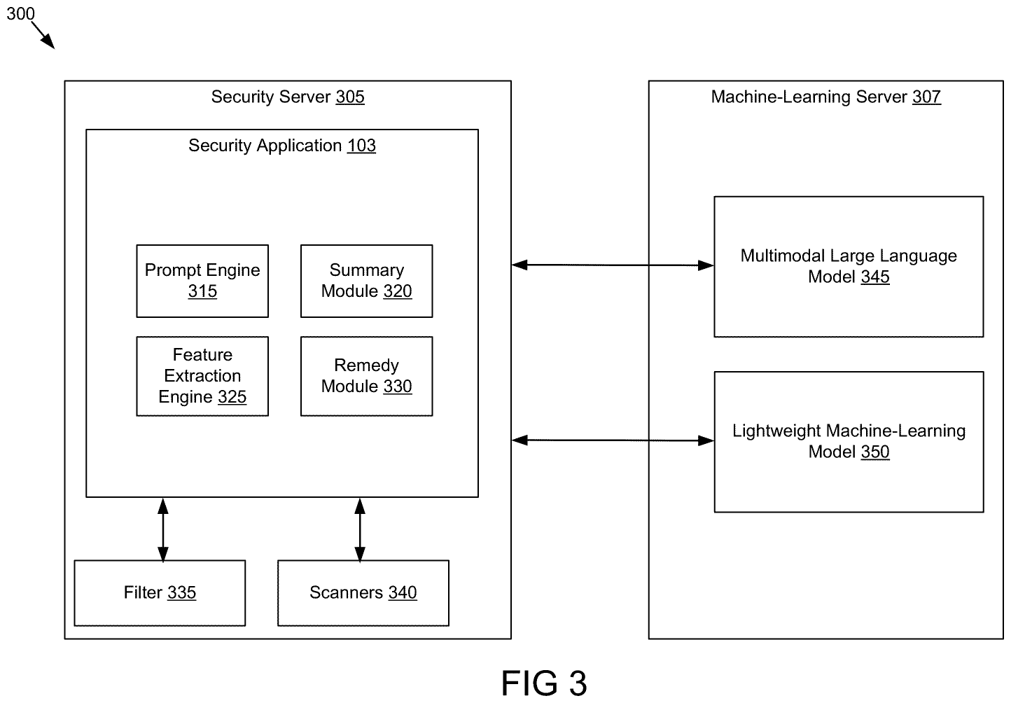

FIG. 3 is a block diagram of a security system 300 that includes a security server 305 and one or more machine-learning servers 307, according to some embodiments. The security server 305 includes a security application 103, one or more filters 335, and one or more scanners 340. The machine-learning server 307 includes a multimodal LLM 345 and one or more lightweight machine-learning models 350. In some embodiments, the multimodal LLM 345 and the one or more lightweight machine-learning models 350 are stored on separate servers.

In some embodiments, the security application 103 is a security gateway. The security application 103 may receive email messages before the email messages are delivered to recipients and, responsive to determining that the email messages are not suspicious, deliver the email messages to recipients. The security application 103 may receive requests from users to view websites and analyze the websites for Not Safe For Work (NSFW) content before the users are provided with access to the websites. NSFW content may include inappropriate subject matter (e.g., adult content, gambling) or suspicious content that could infiltrate a computing device. For example, a website may include code that is executed on the computing device when a computing device renders the website (e.g., a PHP web shell).

The security application 103 requests information from the multimodal LLM 345 and the lightweight machine-learning model 350 to help determine whether content is suspicious. However, machine-learning models may be too computationally expensive and slow for every type of content to be analyzed by the multimodal LLM 345 and the lightweight machine-learning model 350. As a result, in some embodiments, the security application 103 uses one or more filters 335 and/or one or more scanners 340 that scan and/or filter email messages and/or websites, respectively, to identify which content is provided to the multimodal LLM 345 and the lightweight machine-learning model 350.

In some embodiments, the one or more filters 335 and/or one or more scanners 340 identify risk factors in the content. The filters 335 and/or scanners 340 may compare the content against databases of different risk factors and identify a risk. In some embodiments, the filters 335 and/or the scanners 340 are designed to identify specific types of risks. For example, one filter 335 may filter content for suspicious domains, a scanner 340 may identify suspicious Uniform Resource Locator (URL) in content, etc. The risk factors may include an external email message, a suspicious reputation associated with a sender of the content, whether the content is from an email message associated with a new sender or a new domain, an identification of URL that is part of the content, whether a website includes words that are associated with prohibited content, etc.

If the content includes a risk factor, the security application 103 transmits the one or more email messages to the multimodal LLM 345, which returns a summary report and optionally the lightweight machine-learning model 350, which generates a classification of suspicious content based on the summary report (e.g., based on features identified from the summary report). The filters 335 and/or scanners 340 may be used as a first pass of content to reduce the number of content items that are reviewed by the multimodal LLM 345. In some embodiments, the risk factor is associated with a riskiness score (e.g., determined by use of filters 335 and/or scanners 340) and email messages and websites are provided to the multimodal LLM 345 and the lightweight machine-learning model 350 responsive to the riskiness score exceeding a threshold value.

The security application 103 may include a prompt engine 315, a summary module 320, a feature extraction engine 325, and a remedy module 330.

The prompt engine 315 receives an email message or a request to access a website. In some embodiments, the prompt engine 315 renders the content of the email message or the website to generate an image of the email message. For example, the prompt engine 315 may render email content that includes HTML and uses Cascading Style Sheets (CSS) as a webpage and obtain an image of the rendered webpage. The email content may also include one or more message images (e.g., rendered for display as part of the email) that may be instrumental in fooling users during a phishing attempt because images within message content or an email message convey additional information, such as using the same colors, fonts, and/or logos of well-known brands to make the phishing attempt look legitimate. In some embodiments, the prompt engine 315 may identify one or more Uniform Resource Locators (URLs) in the content and provide the URLs as part of the prompt.

The prompt engine 315 generates a prompt that a command for a multimodal LLM 345 to analyze content from an email message (e.g., the image generated by the prompt engine 315) or a website (e.g., a screenshot of the website, as generated by the prompt engine 315) and generate a summary report. In some embodiments, the command requests an identification of suspicious elements in a header of an email message and/or a body of the email message. The prompt engine 315 provides the prompt and the content to the multimodal LLM 345. The content includes text from the email message or the website, one or more message images from the email message, and one or more images generated by the prompt engine 315 by rendering the email content. In some embodiments, the prompt engine 315 formats the prompt based on the number of tokens that the particular multimodal LLM 345 is configured to accept. For example, different LLMs may range from accepting between 8,000 and 32,768 tokens, which corresponds to 6,200 to 25,000 words, respectively.

The summary report generated by the multimodal LLM 345 in response to the prompt describes aspects of suspiciousness in the email message or the website based on common indicators of phishing, fraud, or malicious intent. The summary report may include an overview of content of an email message, an identification of suspicious elements associated with an email domain, an identification of suspicious text, an identification of a suspicious link, an identification of a suspicious image, and/or an identification of an impersonation.

In some embodiments, the prompt engine 315 provides a prompt to the multimodal LLM 345 to generate a summary report that includes a summary section, a suspicious elements domain content section, a suspicious text section, a suspicious links section, a suspicious images section, an impersonated target in the image section, and/or a suspiciousness score. The summary is a brief overview of the email message or the webpage. The suspicious elements domain content section includes the results determined by the multimodal LLM 345 that indicate whether the sender's email domain is consistent with content of the email message or the website.

The multimodal LLM 345 is provided a prompt that requests the multimodal LLM 345 to detect domain spoofing or use of domains similar to reputable domains (e.g., that can mislead the email recipient). The suspicious text section highlights text in an email message or a website that indicate a sense of urgency, incite immediate action, or otherwise is intended to manipulate the recipient emotionally. The suspicious links section includes links found in the email message or the website with an assessment for potential malicious intent, especially links that direct to suspicious or misspelled domains. The suspicious images section includes an analysis of the accompanying screenshots for any indicators of phishing. The impersonated target in image section identifies impersonated brands or targets in the images where the sender's domain does not match the target. The suspiciousness score includes an overall score (e.g., between 0.0 for not suspicious and 1.0 for extremely suspicious) based on aggregated suspicious indicators found in the email message or the website. In some embodiments, the summary report for a website also includes a categorization that identifies a probability that the website is a type of website, such as gambling, weapons, sports, and/or games.

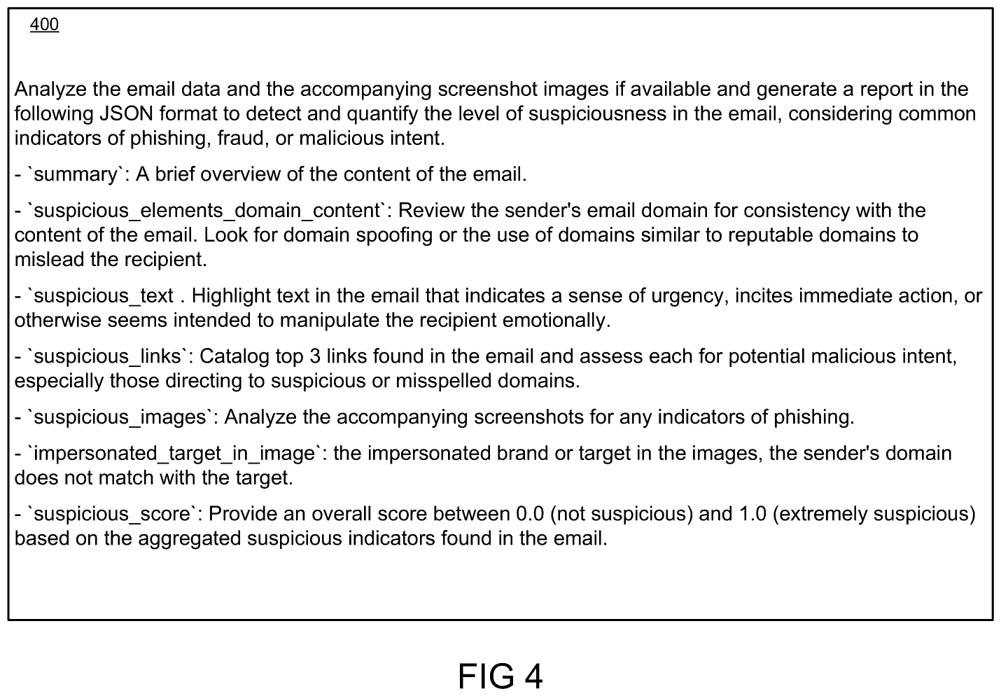

FIG. 4 is an example prompt 400 to an LLM to analyze an email message, according to some embodiments described herein. The prompt 400 includes a command to generate a summary report in a JavaScript Object Notation (JSON) format, although other formats (e.g., JavaScript, Protocol Buffers, MessagePack, etc.) may also be used.

The multimodal LLM 345 is a deep learning model that performs natural language processing of text and images. The multimodal LLM 345 receives a prompt, text, and images, and outputs text that is responsive to the prompt based on the text and images.

In some embodiments, the multimodal LLM 345 generates the summary report and generates embeddings of text and descriptions of the one or more images. The text and descriptions of the one or more images that are used to generate the embeddings may be the same as the text and descriptions that are part of the summary report. The multimodal LLM 345 may include a first component that generates descriptions of the one or more images and a second component that generates one or more embeddings.

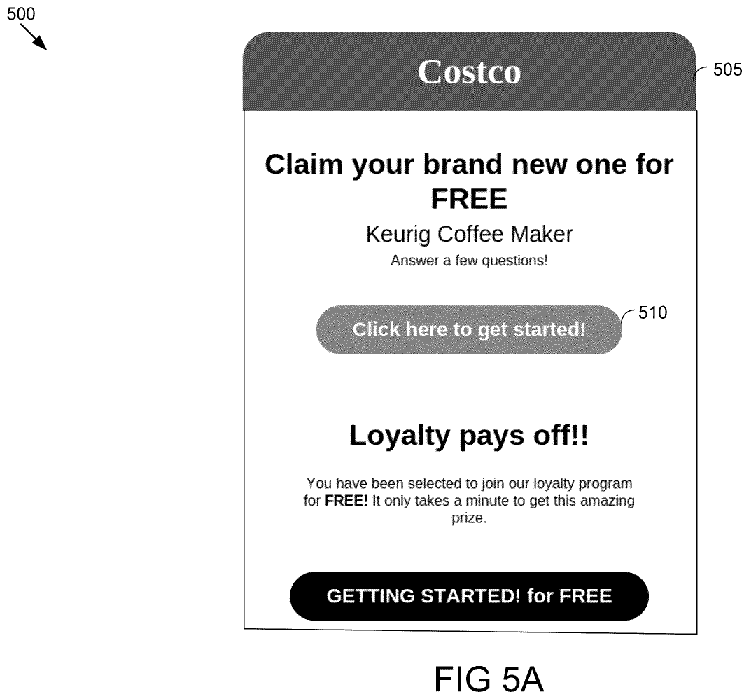

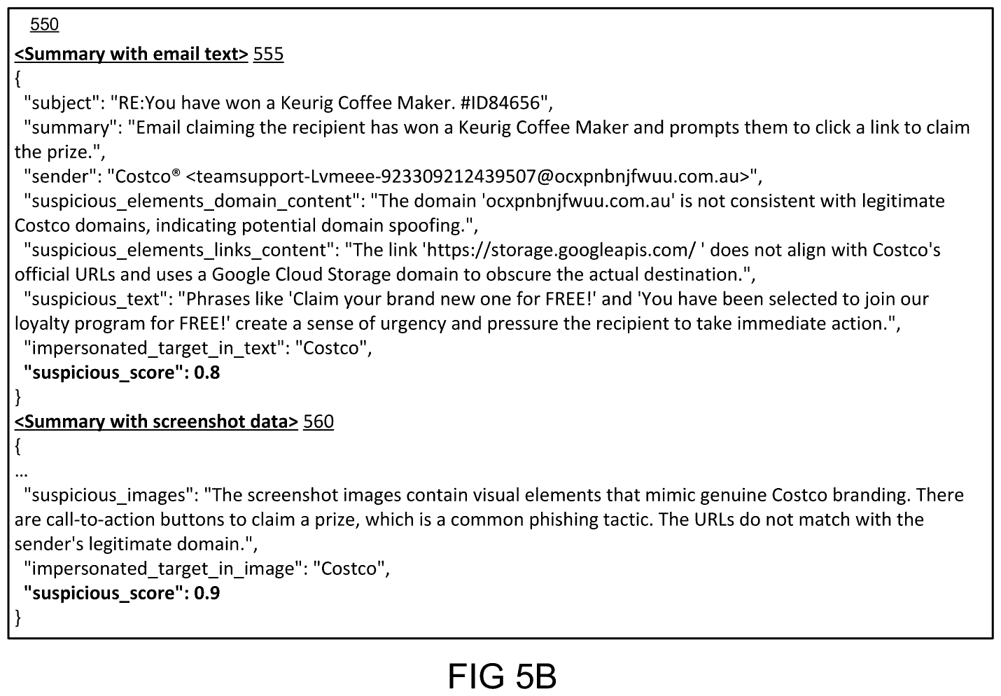

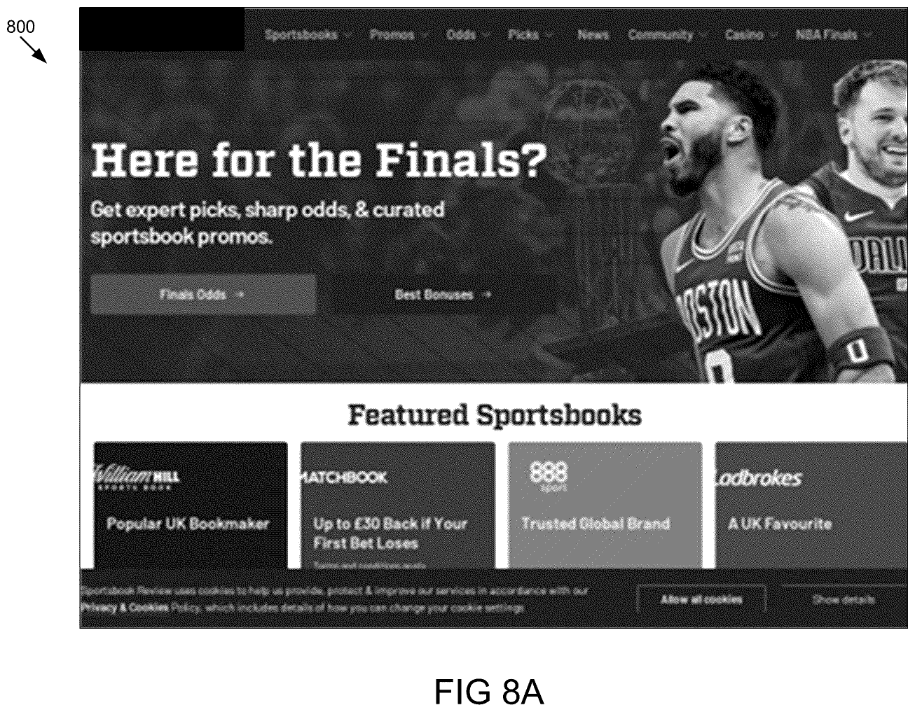

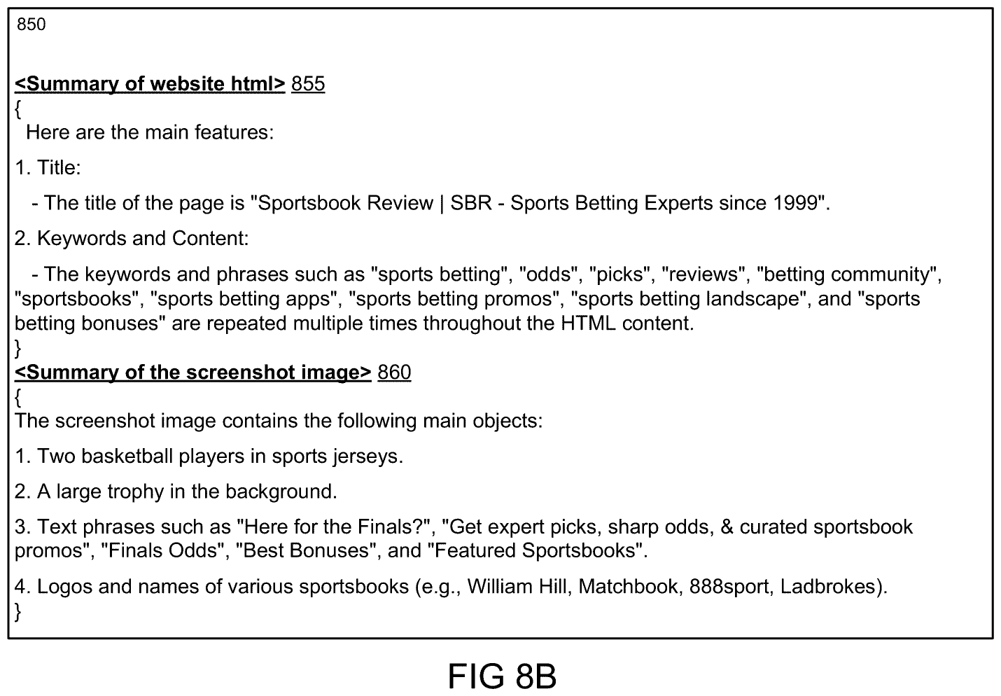

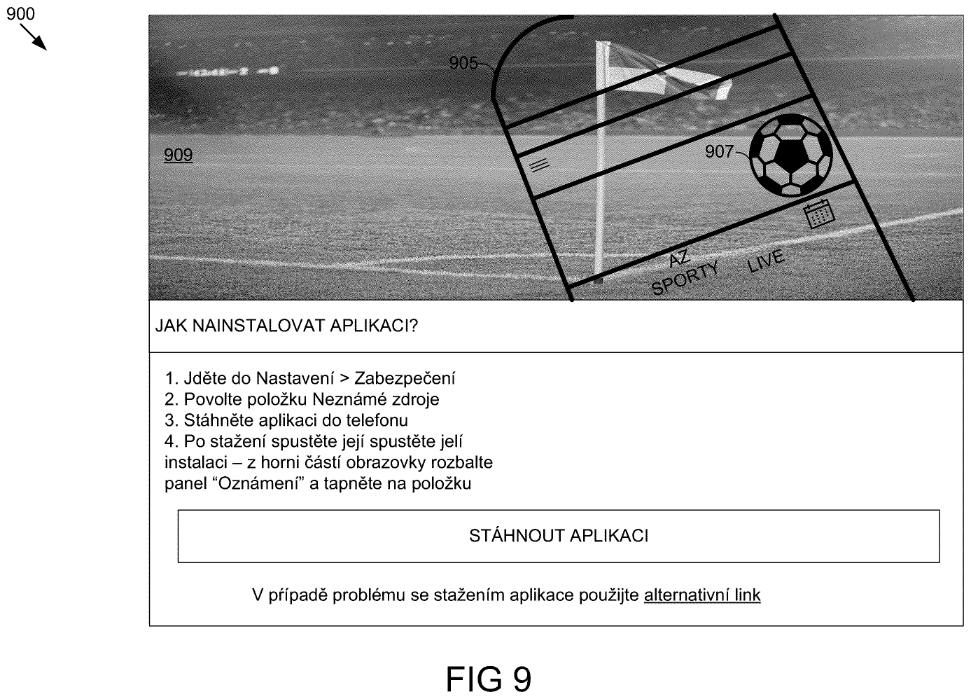

The summary module 320 receives the summary report from the multimodal LLM 345. The descriptions below include example email messages and corresponding summary reports (FIGS. 5A-5B, FIGS. 6A-6B, FIG. 7) and example websites (FIG. 8A, FIG. 9) as well as a corresponding summary report (FIG. 8B).

FIG. 5A is an example image 500 of an email message, according to some embodiments described herein. The example image 500 is a phishing attempt that impersonates an email from Costco®. The example image 500 includes a top portion 505 with a red background that matches the color attributes used by Costco® to make the email message appear legitimate. The image 500 also includes a clickable button 510 that is displayed in a blue color that is also associated with Costco®. For example, the Costco® website advertises “Costco® Wholesale” where “Costco®” uses the same red color attributes and “Wholesale” uses the same blue color attributes that are included in the image 500. The clickable button 510 is associated with a URL. One of the factors analyzed by the multimodal LLM 345 is whether the URL associated with the clickable button 510 is associated with the brand being used in the image 500. For example, the multimodal LLM 345 identifies whether the URL includes “COSTCO” in the domain name or if it is associated with a different domain name.

FIG. 5B is an example summary report 550 for the email message of FIG. 5A, generated by an LLM, according to some embodiments described herein. The summary report 550 includes a summary of email text 555 where text and not an image was provided to the multimodal LLM 345 and a summary of screenshot data 560 that is in addition to the items addressed in the summary of email text 555. The summary of email text 555 includes a subject of the email message, a summary, a sender, suspicious elements domain content, suspicious elements links content, suspicious text, an impersonated target in text, and a suspicious score. The sender includes an identification that the email message claims to be from Costco®, but the email address for the sender does not include the domain name “Costco. ” The suspicious elements links content identifies that the URL does not align with Costco's® official URL and instead uses a Google® Cloud Storage domain.

The summary of screenshot data 560 includes a description of suspicious images, an impersonated target in the image, and a suspicious score. The summary of screenshot data 560 includes a situation where both email text and an image was submitted. The description of the email text is not repeated (as indicated by the ellipses) since the text is the same as the summary of email text 555. The suspiciousness score is 0.9 as compared to the 0.8 suspiciousness score provided if the email text and not screenshots are provided to the multimodal LLM 345. The suspiciousness score is higher when the screenshot data is included because it is an additional example of an attempt to impersonate Costco®.

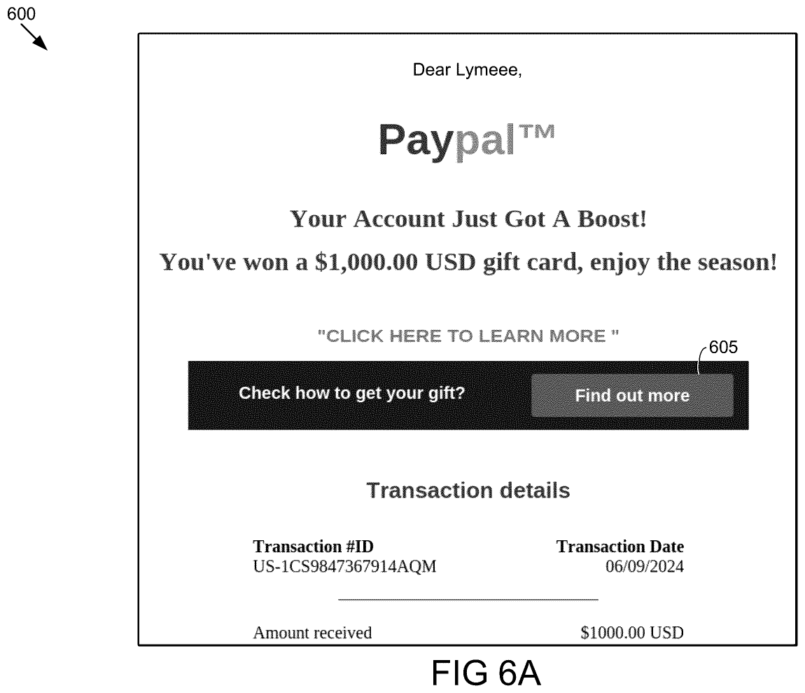

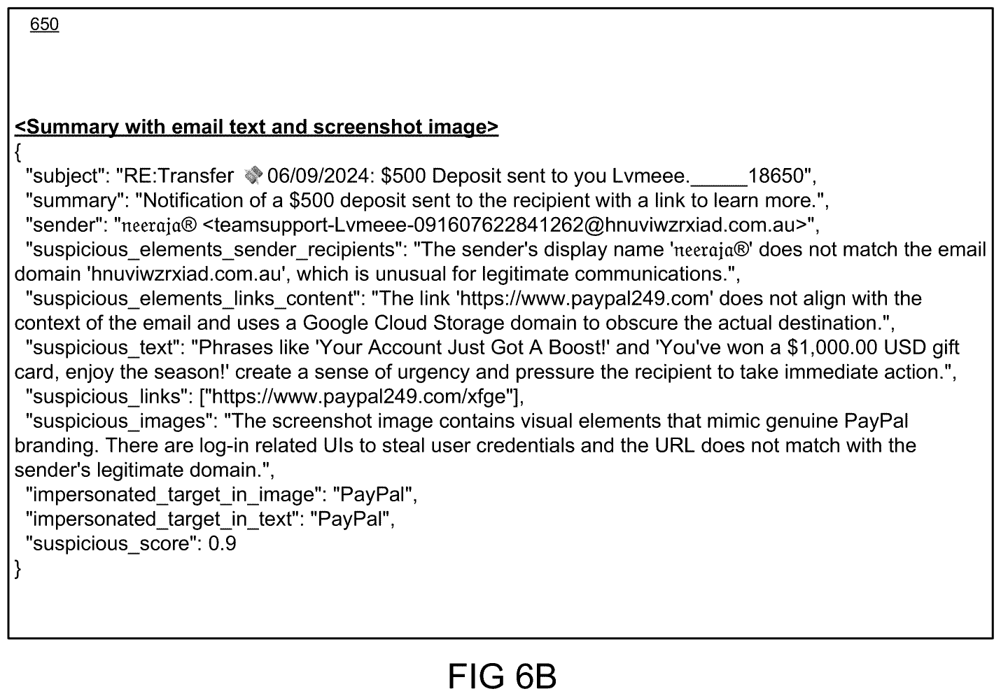

FIG. 6A is another example image 600 of an email, according to some embodiments described herein. The image 600 includes the brand “Paypal™” with “Pay” in medium blue and “pal™” in light blue. Although the company uses “PayPal” with the second “P” capitalized as well, the presentation is close enough to PayPal® to mislead people into thinking the email is from PayPal®. The image 600 includes a clickable link 605 that is associated with a URL.

FIG. 6B is another example summary report 650 for the email message of FIG. 6A, generated by an LLM, according to some embodiments described herein. This summary report 650 includes both the email text and the screenshot image. The summary report 650 includes a subject of the email message, a summary, a sender, suspicious elements in the sender recipients, suspicious elements in the links content, suspicious text, suspicious links, suspicious images, an impersonated target in the image, an impersonated target in the text, and a suspicious score. In this example, the link includes the “paypal” domain name but is not an authorized PayPal® URL. The suspicious images section identifies that the URL associated with the clickable link 605 in FIG. 6A is associated with a user interface that is designed to steal user credentials for the user's PayPal® account.

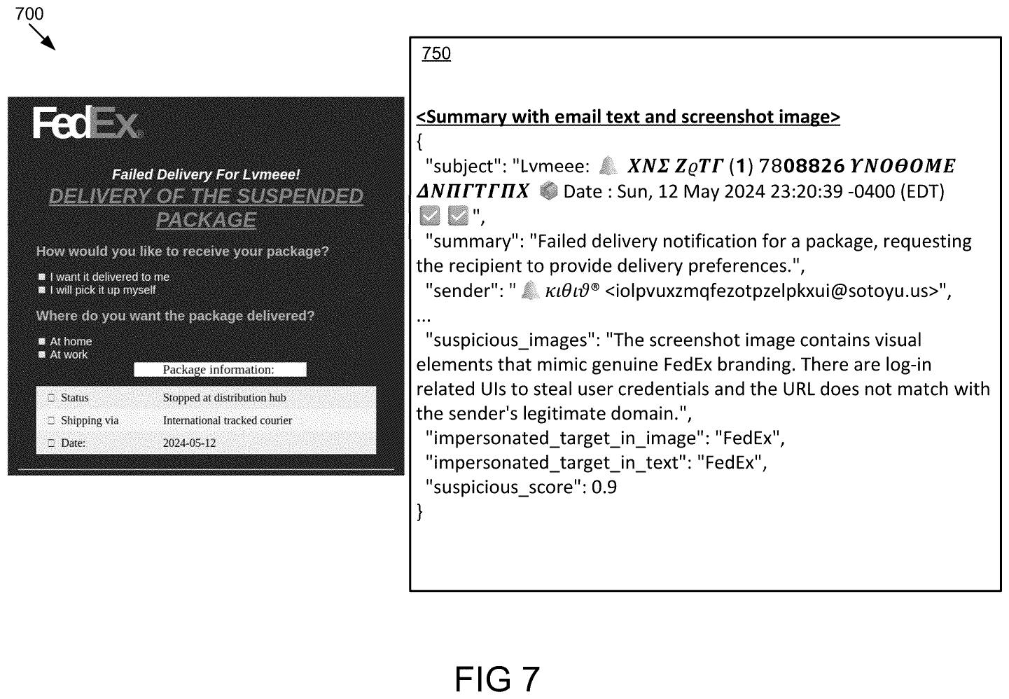

FIG. 7 is another example image 700 of an email message and a corresponding example summary report 750, according to some embodiments described herein. The image 700 includes a background that has the purple attributes associated with FedEx® and the FedEx® logo with “Fed” in white and “Ex®” in orange. The summary report 750 includes a subject of the email message, a summary, a sender, suspicious images, an impersonated target in the image, an impersonated target in the text, and a suspicious score.

The feature extraction engine 325 extracts features from the summary report. In some embodiments, the feature extraction engine 325 performs feature extraction directly. In some embodiments, the feature extraction engine 325 communicates with a feature embedding service.

In some embodiments where the feature extraction engine 325 performs feature extraction of the summary report directly, the feature extraction engine 325 may use Term Frequency-Inverse Document Frequency (TF-IDF) to extract features. TF-IDF is a natural language processing technique that identifies how important a term is within a document (i.e., the summary report). The TF-IDF process may be used for summary reports associated with email messages.

The feature extraction engine 325 calculates a TF score for a term by dividing a number of times the term appears in the content by a total number of terms in the document. The feature extraction engine 325 calculates an IDF score by calculating a log of the number of content items in a training dataset that includes both benign email messages and malicious email messages by a number of documents in the training dataset that contain the term. The feature extraction engine 325 extracts word tokens from the email messages and calculates a TF-IDF score by multiplying the TF by the IDF.

In some embodiments, the feature extraction engine 325 receives embeddings representative of the content from a feature embedding service. The feature embedding service transforms words or phrases in the summary report into numerical vectors that capture meanings and relationships. The feature embedding service may be performed by the multimodal LLM 345. The embeddings may be used when the content is associated with a website. In some embodiments, the multimodal LLM 345 receives a description of the one or more images and generates the embeddings based on the text and the descriptions of the one or more images. In some embodiments, the feature extraction engine 325 uses both TF-IDF to extract features of the text and the multimodal LLM 345 to obtain embeddings that are representative numerical vectors.

The feature extraction engine 325 provides the extracted features as input to one or more lightweight machine-learning models 350. The lightweight machine-learning model 350 is trained to receive extracted features and output a classification of the content that indicates whether the content is suspicious. For example, the lightweight machine-learning model 350 may output a binary determination of suspicious content or not suspicious content, or a more nuanced classification, such as a second suspiciousness score. In instances where the content is a website, the lightweight machine-learning model 350 may output a classification of the website.

The lightweight machine-learning model 350 may be trained using training data that includes ground truth data. For example, the ground truth data may include text and images that are labelled as clean examples (i.e., content that is not suspicious) and text and images that are labelled as unclean examples (i.e., content that is suspicious for one or more of a variety of reasons). In some embodiments, the lightweight machine-learning model 350 uses a gradient boosting framework to output deicisions, such as XGBoost, or a random decision forest that combines the output of multiple decision trees to reach a single result.

Images of a website may be useful to supplement the text being used to classify the website. FIG. 8A is an example image 800 of a gambling website, according to some embodiments described herein. In this example, the image includes two basketball players, a background with a trophy, and text phrases that include “Up to £30 Back if Your First Best Loses. ” FIG. 8B is an example summary report 850 for the gambling website of FIG. 8A, according to some embodiments described herein. The summary report 850 includes a summary of the website HTML 855 and a summary of the screenshot image 860. The summary of the website HTML 855 includes a title of the website, keywords and content. The summary of the screenshot image 860 includes a description of the two basketball players, a trophy, text phrases, and logos and names of sportsbooks.

When the text and not the image 800 from the website was provided to a machine-learning model for classification, the machine-learning model misclassified the website as a sports website. When the text and image 800 were provided to the multimodal LLM 345 and the lightweight machine-learning model 350, the output identified the content as being associated with a gambling website. As a result, the multimodal LLM 345 and the lightweight machine-learning model 350 correctly identify the website as being NSFW.

FIG. 9 is an example image 900 of a non-English gambling website, according to some embodiments described herein. The image 900 includes a mobile device 905 with an image of a soccer ball 907 and a background image 909 of a game field. When a machine-learning model received the text data associated with the website, the machine-learning model output a classification that the website was a sports website. When the text and image 900 were provided to the multimodal LLM 345 and the lightweight machine-learning model 350, the output identified the content as being associated with a gambling website.

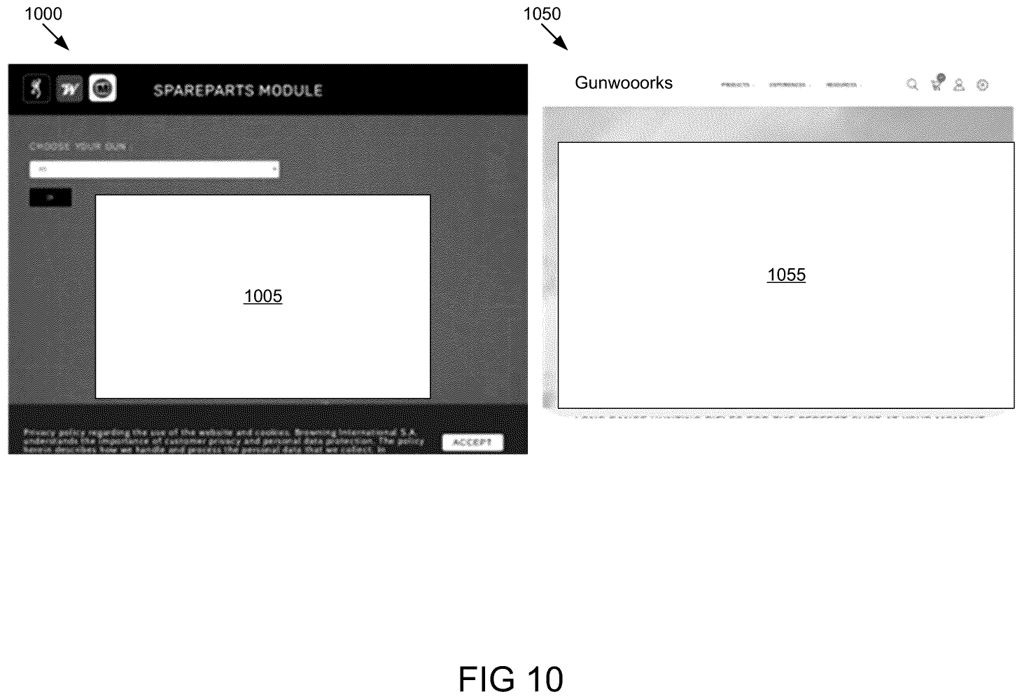

FIG. 10 includes two example images 1000, 1050 of websites, according to some embodiments described herein. The first image 1000 and the second image 1050 include limited textual information, but boxes 1005 and 1055, respectively, represent images of weapons. The multimodal LLM 345 and the lightweight machine-learning model 350 correctly classified both websites as being weapons websites. Without the images, the websites may have been classified as belonging to a different group given the dearth of text in the websites.

The remedy module 330 determines one or more remedial actions in response to a determination that content is suspicious. In some embodiments, the remedy module 330 determines that content is suspicious if the suspiciousness score exceeds a threshold value (e.g., if the suspiciousness score ranges from 0.0 to 1.0 and the threshold value is 0.9). If the content is an email message, the remedial action may include deleting the email message, quarantining the email message, delivering the email message with a warning, delivering the email message with the summary report, delivering a modified email message where an original URL from the email message is replaced with a modified URL, etc. If the content is from a website, the remedial action may include blocking users from accessing the website.

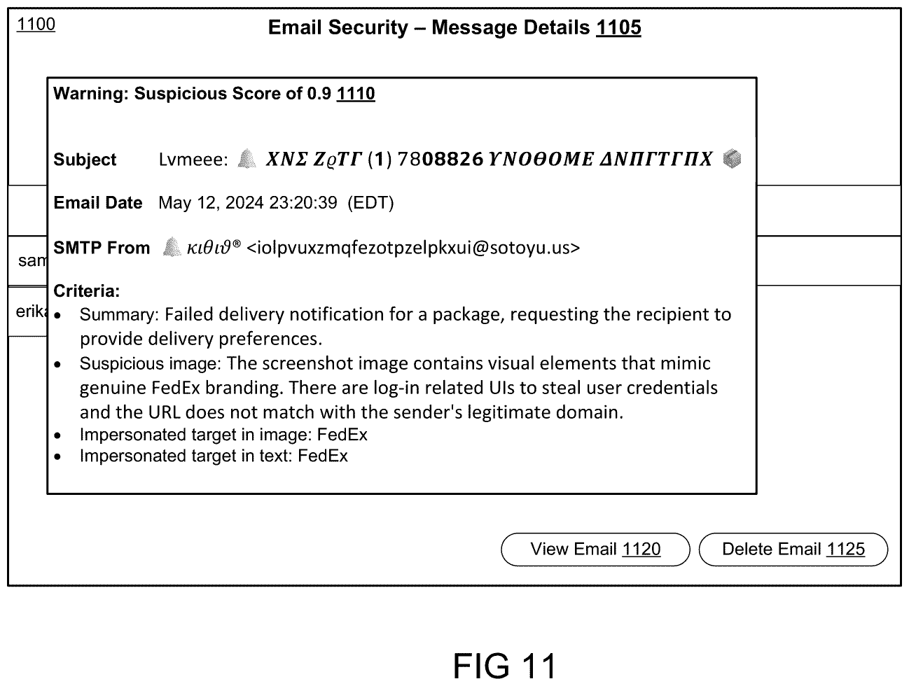

FIG. 11 is an example user interface 1100 that includes a warning to a recipient about the email message based on the summary report, according to some embodiments described herein. The user interface 1100 includes a list of email messages that have been quarantined to an email security 1105 section. Responsive to a user selecting one of the email messages, the user interface 1100 includes a warning 1110 pop-up that includes the following information from the summary report: a suspicious score of 0.9, a subject, an email date, a sender email address, and criteria that indicate that the email message is suspicious. The criteria include a summary where the recipient is asked to provide delivery preferences, a suspicious image, an impersonated target in the image, and an impersonated target in the text.

The user interface 1100 includes options for a user to view the email 1120 or to delete the email 1125. In some embodiments, the email message is viewable with URLs that are inactivated or that redirect to a different website to protect the client device from being involved in a phishing attempt.

### Example Method

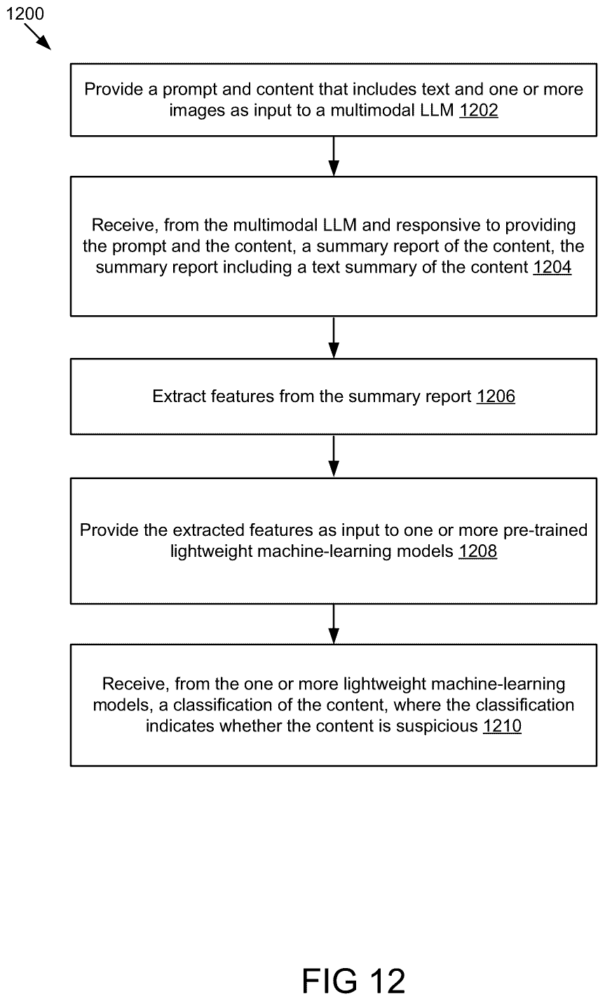

FIG. 12 is a flow diagram of an example method to classify a suspiciousness of content, according to some embodiments described herein. The method 1200 may be performed by a security application, such as the security application 103 in FIGS. 1, 2, or 3.

The method 1200 may begin at block 1202. At block 1202, a prompt and content that includes text and one or more images as input are provided to a multimodal LLM. In some embodiments, before providing the content to the multimodal LLM, the content is determined to be associated with a risk factor, where the risk factor is selected from a group of the content being from an external email message, a suspicious reputation associated with a sender of the content, the content is from an email message associated with a new sender or a new domain, an identification of a suspicious Uniform Resource Locator (URL) that is part of the content, prohibited words that are associated with the content, and combinations thereof and where wherein providing the content to the multimodal LLM is performed responsive to determining that the content is associated with the risk factor. Block 1202 may be followed by block 1204.

At block 1204, a summary report of the content is received from the multimodal LLM and responsive to providing the prompt and the content, the summary report including a text summary of the content. Block 1204 may be followed by block 1206.

At block 1206, features are extracted from the summary report. In some embodiments, the summary report includes one or more parameters selected from a group of an overview of content of an email message, an identification of suspicious elements associated with an email domain, an identification of suspicious text, an identification of a suspicious link, an identification of a suspicious image, an identification of an impersonation, and combinations thereof. In some embodiments, the features from the summary report comprises determining a respective Term Frequency-Inverse Document Frequency (TF-IDF) score for a plurality of terms in the text summary of the content. In some embodiments, extracting the features from the summary report comprises obtaining one or more embeddings representative of the content from the multimodal LLM. In some embodiments, obtaining the one or more embeddings representative of the content includes: obtaining, from the multimodal LLM, a respective description of the one or more images and generating, by the multimodal LLM, the one or more embeddings based on the text and the descriptions of the one or more images. In some embodiments, the multimodal LLM includes a first component that generates descriptions of the one or more images and a second component that generates the one or more embeddings. Block 1206 may be followed by block 1208.

At block 1208, the extracted features are provided as input to one or more pre-trained lightweight machine-learning models. Block 1208 may be followed by block 1210.

At block 1210, a classification of the content is received from the one or more lightweight machine-learning modals, where the classification indicates whether the content is suspicious. In some embodiments, the summary report includes a first suspiciousness score and the classification includes a second suspiciousness score for the content. In some embodiments, the content is from a website and the classification includes a probability that the website is a type of website selected from a group of gambling, weapons, sports, games, and combinations thereof.

In some embodiments, the method 1200 further includes responsive to the classification indicating that the content is suspicious, performing a remedial action. In some embodiments, the content is an original email message and the remedial action is selected from a group of deleting the email message, quarantining the email message, delivering the email message with a warning, delivering the email message with the summary report, delivering a modified email message where an original Uniform Resource Locator (URL) from the original email message is replaced with a modified URL, and combinations thereof. In some embodiments, the content is from a website and the remedial action includes blocking users from accessing the website.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMs, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method to identify suspicious content, the method comprising:
providing a prompt and content that includes text and one or more images as input to a multimodal large language model (LLM);
receiving, from the multimodal LLM and responsive to providing the prompt and the content, a summary report of the content, the summary report including a text summary of the content;
extracting features from the summary report;
providing the extracted features as input to one or more pre-trained lightweight machine-learning models; and
receiving, from the one or more lightweight machine-learning models, a classification of the content, wherein the classification indicates whether the content is suspicious.

2. The method of claim 1, further comprising:
before providing the content to the multimodal LLM, determining that the content is associated with a risk factor;
wherein the risk factor is selected from a group of the content being from an external email message, a suspicious reputation associated with a sender of the content, the content is from an email message associated with a new sender or a new domain, an identification of a suspicious Uniform Resource Locator (URL) that is part of the content, prohibited words that are associated with the content, and combinations thereof; and
wherein providing the content to the multimodal LLM is performed responsive to determining that the content is associated with the risk factor.

3. The method of claim 1, wherein the summary report includes one or more parameters selected from a group of an overview of content of an email message, an identification of suspicious elements associated with an email domain, an identification of suspicious text, an identification of a suspicious link, an identification of a suspicious image, an identification of an impersonation, and combinations thereof.

4. The method of claim 1, wherein the summary report includes a first suspiciousness score for the content and the classification includes a second suspiciousness score for the content.

5. The method of claim 1, wherein the content is from a website and the classification includes a probability that the website is a type of website selected from a group of gambling, weapons, sports, games, and combinations thereof.

6. The method of claim 1, the method further comprising:
responsive to the classification indicating that the content is suspicious, performing a remedial action.

7. The method of claim 6, wherein the content is an original email message and the remedial action is selected from a group of deleting the email message, quarantining the email message, delivering the email message with a warning, delivering the email message with the summary report, delivering a modified email message where an original Uniform Resource Locator (URL) from the original email message is replaced with a modified URL, and combinations thereof.

8. The method of claim 6, wherein the content is from a website and the remedial action includes blocking users from accessing the website.

9. The method of claim 1, wherein extracting the features from the summary report comprises determining a respective Term Frequency-Inverse Document Frequency (TF-IDF) score for a plurality of terms in the text summary of the content.

10. The method of claim 1, wherein extracting the features from the summary report comprises obtaining one or more embeddings representative of the content from the multimodal LLM.

11. The method of claim 10, wherein obtaining the one or more embeddings representative of the content comprises:
obtaining, from the multimodal LLM, a respective description of the one or more images; and
generating, by the multimodal LLM, the one or more embeddings based on the text and the descriptions of the one or more images.

12. The method of claim 10, wherein the multimodal LLM includes a first component that generates descriptions of the one or more images and a second component that generates the one or more embeddings.

13. A system comprising:
one or more processors; and
one or more computer-readable media, having instructions stored thereon that, when executed by the one or more processors, cause the one or more processors to perform operations comprising:
providing a prompt and content that includes text and one or more images as input to a multimodal large language model (LLM);
receiving, from the multimodal LLM and responsive to providing the prompt and the content, a summary report of the content, the summary report including a text summary of the content;
extracting features from the summary report;
providing the extracted features as input to one or more pre-trained lightweight machine-learning models; and
receiving, from the one or more lightweight machine-learning models, a classification of the content, wherein the classification indicates whether the content is suspicious.

14. The system of claim 13, wherein the operations further include:
before providing the content to the multimodal LLM, determining that the content is associated with a risk factor;
wherein the risk factor is selected from a group of the content being from an external email message, a suspicious reputation associated with a sender of the content, the content is from an email message associated with a new sender or a new domain, an identification of a suspicious Uniform Resource Locator (URL) that is part of the content, prohibited words that are associated with the content, and combinations thereof; and
wherein providing the content to the multimodal LLM is performed responsive to determining that the content is associated with the risk factor.

15. The system of claim 13, wherein the summary report includes one or more parameters selected from a group of an overview of content of an email message, an identification of suspicious elements associated with an email domain, an identification of suspicious text, an identification of a suspicious link, an identification of a suspicious image, an identification of an impersonation, and combinations thereof.

16. The system of claim 13, wherein the summary report includes a first suspiciousness score for the content and the classification includes a second suspiciousness score for the content.

17. A non-transitory computer-readable medium with instructions stored thereon that, responsive to execution by one or more processing devices, causes the one or more processing devices to perform operations comprising:
providing a prompt and content that includes text and one or more images as input to a multimodal large language model (LLM);
receiving, from the multimodal LLM and responsive to providing the prompt and the content, a summary report of the content, the summary report including a text summary of the content;
extracting features from the summary report;
providing the extracted features as input to one or more pre-trained lightweight machine-learning models; and
receiving, from the one or more lightweight machine-learning models, a classification of the content, wherein the classification indicates whether the content is suspicious.

18. The computer-readable medium of claim 17, wherein the operations further include:
before providing the content to the multimodal LLM, determining that the content is associated with a risk factor;
wherein the risk factor is selected from a group of the content being from an external email message, a suspicious reputation associated with a sender of the content, the content is from an email message associated with a new sender or a new domain, an identification of a suspicious Uniform Resource Locator (URL) that is part of the content, prohibited words that are associated with the content, and combinations thereof; and
wherein providing the content to the multimodal LLM is performed responsive to determining that the content is associated with the risk factor.

19. The computer-readable medium of claim 17, wherein the summary report includes one or more parameters selected from a group of an overview of content of an email message, an identification of suspicious elements associated with an email domain, an identification of suspicious text, an identification of a suspicious link, an identification of a suspicious image, an identification of an impersonation, and combinations thereof.

20. The computer-readable medium of claim 17, wherein the summary report includes a first suspiciousness score for the content and the classification includes a second suspiciousness score for the content.
